(19) United States
(12) Patent Application Publication
(10) Pub. No.: US 2005/0101190 A1
(43) Pub. Date: May 12, 2005

(54) Terminal with flexible tail

(76) Inventors: Mei Lin Ong, Singapore (SG); Ser Klat Toh, Singapore (SG)

Correspondence Address: MOLEX INCORPORATED, 2222 WELLINGTON COURT, LISLE, IL, 60532, US

(21) Appl. No.: 10/706,260

(22) Filed: Nov. 12, 2003

(51) Int. Cl. H01R 24/00

(52) U.S. Cl. 439/637

(57) ABSTRACT

A terminal for an electrical connector includes a lower portion having a leg and a tail. A notch is provided between the leg and the tail of the lower portion. The notch allows the tail to flex toward and away from the leg. Thus, the tail moves laterally relative to printed circuit board to which the electrical connector is attached.

### BACKGROUND OF THE INVENTION

This invention is generally directed to a terminal of an electrical connector. More particularly, the invention contemplates a terminal which provides an improved connection with a printed circuit board.

It is well known to surface mount an electrical connector to a printed circuit board by soldering tail portions of each terminal to contact pads provided on the printed circuit board. An electrical connection can then be made between an electrical component and the printed circuit board by mating the electrical component to the connector.

A pair of prior art terminals 10 is shown in FIG. 1. A lower portion 12 of each terminal 10 includes a tail 14. When soldering the terminals 10 of the electrical connector to the contact pads of the printed circuit board (not shown) the tail 14 of each terminal 10 is placed in the center of each contact pad. The printed circuit board and terminals 10, along with solder, are heated to form the solder joint. As the printed circuit board and the terminals 10 are heated, expansion of the printed circuit board and terminals 10 occurs. As the printed circuit board and the terminals 10 cool, the printed circuit board and the terminals 10 contract, however, the contraction of the terminals 10 occurs at a different rate than the contraction of the printed circuit board. As a result, the tail 14 of each terminal 10 is laterally displaced with respect to the contact pad of the printed circuit board and the newly formed joint between the terminal 10 and the printed circuit board fractures.

The present invention provides a terminal which overcomes the problems presented in the prior art and which provides additional advantages over the prior art, such advantages will become clear upon a reading of the attached specification in combination with a study of the drawings.

### OBJECTS AND SUMMARY OF THE INVENTION

A general object of the present invention is to provide a terminal which substantially eliminates the occurrence of fractures in the solder joint between the contact pad of the printed circuit board and the terminal.

An object of the present invention is to provide a terminal which flexes in the lateral direction.

Another object of the present invention is to provide a terminal with reduced impedance.

Briefly, and in accordance with the foregoing, the present invention discloses a terminal for an electrical connector. The terminal includes a base which includes a leg, a tail spaced from the leg and a notch provided between the leg and the tail. The tail includes an upright portion and a foot extending generally perpendicularly from the upright portion. The foot provides an electrical connection between the contact pad of the printed circuit board and the remainder of the terminal. The notch allows the tail to flex in a lateral direction to reduce stress on the solder joint between the contact pad of the printed circuit board and the terminal, thereby eliminating fractures in the solder joint.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is a front elevational view of a left-side terminal and a right-side terminal of the prior art;

FIG. 2 is a perspective view of an electrical connector which includes a plurality of terminals which incorporates features of the present invention;

FIG. 3 is a front elevational view of a left-side terminal and a right-side terminal each incorporating features of the present invention; and

FIG. 4 is a cross-sectional view of the connector of FIG. 2 along line 4-4.

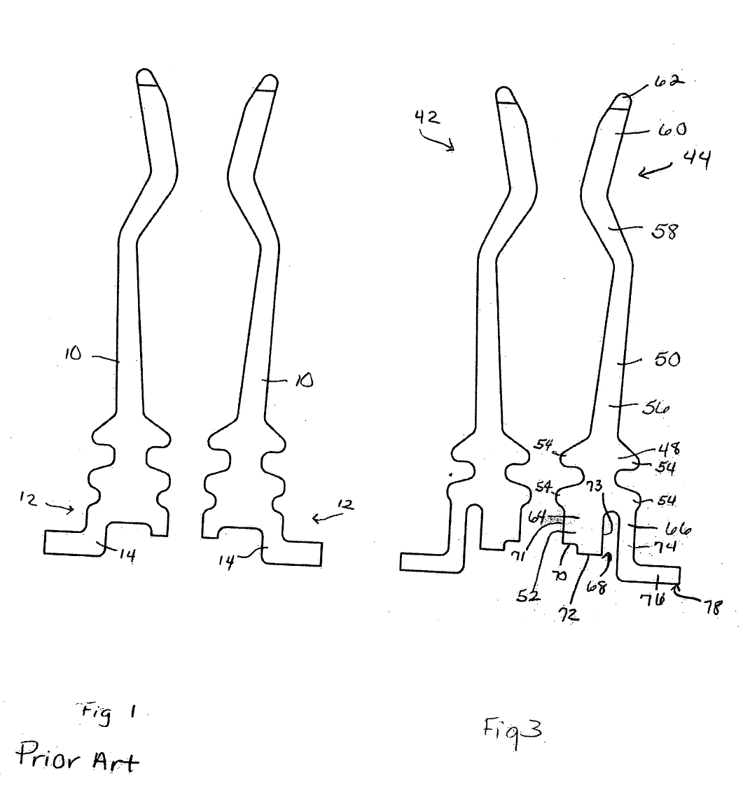

### DETAILED DESCRIPTION OF THE ILLUSTRATED EMBODIMENTS

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

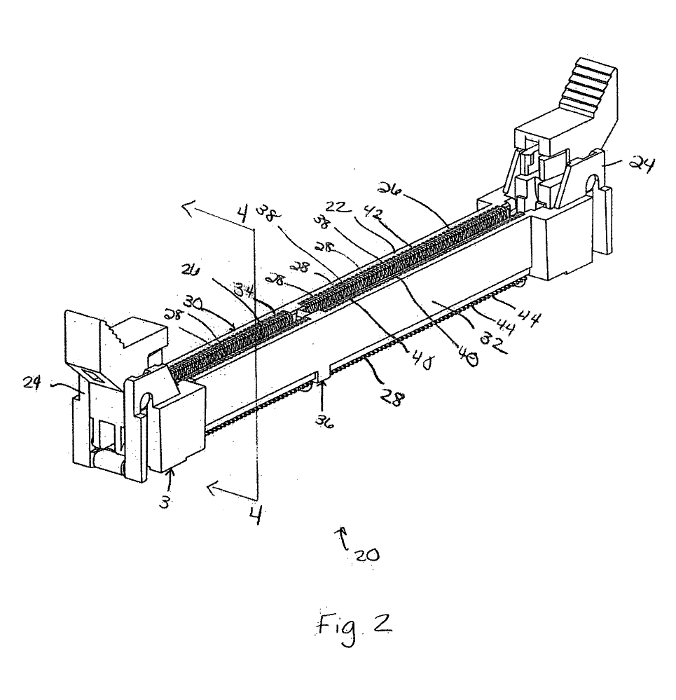

As shown in FIG. 2 an electrical connector 20 includes a dielectric housing 22, mounting structures 24, slots 26, and a plurality of conductive terminals 28 along each slot 26. The housing 22 includes a left wall 30, a right wall 32, a top wall 34 and a bottom wall 36. The slots 26 are provided within the top wall 34 of the housing for receiving electrical components (not shown) to be mated with the electrical connector 20. The bottom wall 36 of the housing is placed in contact with a printed circuit board (not shown). A plurality of left-side terminal passageways 38 extend from the top wall 34 of the housing 22 through the bottom wall 36 of the housing 22 proximate the left wall 30 of the housing 22. A plurality of right-side terminal passageways 40 extend from the top wall 34 of the housing 22 through the bottom wall 36 of the housing 22 proximate the right wall 32 of the housing 22. A left-side terminal 42 is mounted within each left-side terminal passageway 38 and a right-side terminal 44 is mounted within each right-side terminal passageway 40. The terminals 42, 44 provide an electrical connection between the electrical component mated with the electrical connector 20 and the printed circuit board (PCB).

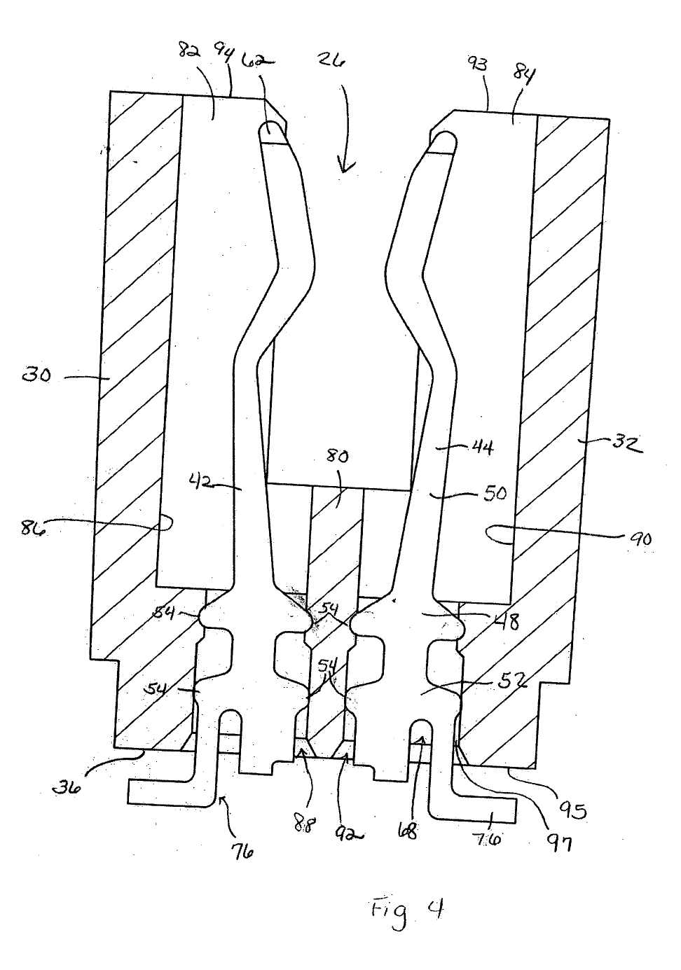

A left side terminal 42 and a right side terminal 44 each incorporating features of the present invention are shown in FIG. 3. As the left and right side terminals 42, 44 are mirror images of one another, the right side terminal 44 will be described in detail with the understanding that except for the difference in orientation, the left side terminal 42 is identical to the right side terminal 44.

The terminal includes a base portion 48, a contact arm 50 extending upwardly from the base portion 46, and a lower portion 52 extending downwardly from the base portion 48. The base portion 48 includes two pair of outwardly extending rounded barbs 54 for engagement with the connector housing 22 as will be described herein.

The contact arm 50 is generally elongated and includes a first portion 56, a second portion 58, a third portion 60 and a tip 62. The first portion 56 extends generally upwardly from the base portion 48. The second portion 58 extends from the first portion 56 and is angled relative to the first portion 56. The third portion 60 extends from the second portion 58 and is angled relative to the second portion 58. A rounded tip 62 extends from the third portion 60.

The lower portion 52 includes a leg 64 and a tail 66. The leg 64 is substantially wider than the tail 66. The width of the leg 64 is predetermined so as to provide a sufficient pushing surface for mounting the terminal 42, 44 within the housing 22 as will be described herein. An arch-shaped notch 68 is provided between the leg 64 and the tail 66. The notch 68 extends upwardly into the lower portion 52 a predetermined distance. As shown, the notch 68 extends upwardly such that the notch 68 extends to a height proximate the lower pair of barbs 54. Thus, the height of the notch 68 is approximately the same as the height of the leg 64.

The leg 64 is generally rectangularly-shaped. A shoulder 70 is provided along the lower edge of the leg 64 and extends inwardly a predetermined distance from an outer edge 71 of the leg 64. A pushing surface 72 is provided proximate the shoulder 70 along the lower edge of the leg 64 and extends from the inner edge 73 to the shoulder 70.

The tail 66 is generally L-shaped and includes and upright extension 74 and a foot 76. The upright extension 74 of the tail 66 is generally rectangularly-shaped and is thinner and longer than the leg 64. The foot 76 is approximately the same width as the upright extension 74 and extends perpendicularly and outwardly from the upright extension 74 such that it extends away from the leg 64. The foot 76 includes a lower surface 78 which contacts the printed circuit board as will be described herein.

As shown in FIG. 4, the left wall 30 and right wall 32 of the housing 22 are generally parallel to each other. A central support 80 is provided between the left and right walls 30, 32 and is generally parallel to the left and right walls 30, 32. The central support 80 does not extend the full height of the left wall 30 and the right wall 32. A left partition wall 82 extends from the left wall 30 to the central support 80. A right partition wall 84 extends from the right wall 32 to the central support 80. Each of the left-side terminals 42 (one of which is shown) is separated from another left-side terminal by a left partition wall 82 and each of the right-side terminals 44 (one of which is shown) is separated from another right-side terminal by a right partition wall 84. The partition walls 82, 84 are used to separate adjacent terminal passageways 38, 40, respectively.

A right-side passageway 90 is defined by the right wall 32, the central support 80 and the right-side partition walls 84 (only one of which is shown). An opening 92 through the bottom wall 36 of the housing 22 provides access to the right side passageway 90. Because the central support 80 does not extend the entire height of the right wall 32, communication is provided between the right-side passageway 90 and the slot 26 above the central support 80. The right terminal 44 is mounted within the right-side passageway 90 and is in communication with the slot 26. The barbs 54 engage the central support 80 and the right wall 32 of the housing 22 to support the terminal 44 within the housing 22.

A left-side passageway 86 is defined by the left wall 30, the central support 80 and the left-side partition walls 82 (only one of which is shown). An opening 88 through the bottom wall 36 of the housing 22 provides access to the left side passageway 86. Because the central support 80 does not extend the entire height of the left wall 30, communication is provided between the left-side passageway 86 and the slot 26 above the central support 80. The left terminal 42 is mounted within the left-side passageway 86 and is in communication with the slot 26 of the housing 22. The barbs 54 engage the central support 80 and the left wall 30 of the housing 22 to support the terminal 42 within the housing 22.

To mount the right-side terminal 44 within the terminal passageway 90, the tip 62 of the terminal 44 is passed through the right side opening 92. As the terminal 44 enters the terminal passageway 90, the barbs 54 of the terminal 44 engage the right wall 32 and the central support 80. A tool is placed in contact with the pushing surface 72 of the terminal 44, and the terminal 44 is pushed upward within the right-side passageway 90 until the barbs 54 firmly engage the right wall 32 and the central support 80 and the terminal 44 is securely mounted in the right-side passageway 90. When the right-side terminal 44 is mounted within the terminal passageway 90, the tip 62 of the right-side terminal 44 is positioned below the upper edge 93 of the right-side partition walls 84 and the foot 76 and the pushing surface 72 of the right-side terminal 44 are positioned below the bottom edge 95 of the right-wall 32. When the right-side terminal 44 is mounted within the terminal passageway 90 a gap 97 is provided between the tail 66 and the right wall 32. The left-side terminal 42 is mounted within the left-side passageway 86 in the same manner as the right-side terminal 44.

In use, the electrical connector 20 is mounted to a printed circuit board and the terminals 42, 44 are soldered to the contact pads of the printed circuit board. The soldering process includes heating of the terminals 42, 44 and the printed circuit board which causes expansion of the terminals 42, 44 and the printed circuit board. Solder is deposited on the feet 74 of the terminals 42, 44 to form joints between the terminals 42, 44 and the printed circuit board. As the terminals 42, 44, printed circuit board and solder cool, the terminals 42, 44 and the printed circuit board contract. Cooling and contractions of the terminals 42, 44 occurs at a different rate than cooling and contraction of the printed circuit board. As a result, a lateral force is provided between the foot 76 of the terminal 42, 44 and the printed circuit board. This lateral force is translated to the tail 66 of the terminals 42, 44. Because of the arch 68 between the leg 64 and the tail 66 of each terminal 42, 44, the tail 66 flexes allowing the tail 66 to move toward and away from the leg 64. In addition, the gap 97 provides clearance for the tail 66 to flex away from the leg 64. The flexibility and lateral movement of the tail 66 alleviates the lateral force between the foot 76 of each terminal 42, 44 and the printed circuit board. As a result, the newly formed solder joint is not fractured.

Another advantage provided by the terminal of the present invention is a reduced impedance. Providing the notch 68 results in the non-inclusion of material at the location of the notch 68. In addition, the foot 76 of the tail 66 is thinner than the tail provided in connection with prior art terminals. The reduction of material used to form the terminal 42, 44 reduces the impedance of the terminal 42, 44.

Although directions such as, for example, top, bottom, up and down have been used to describe various aspects of the invention, it is to be understood that these descriptions have been used to simplify the description of the invention and are not intended to limit the invention to the particular orientation described.

While a preferred embodiment of the present invention is shown and described, it is envisioned that those skilled in the art may devise various modifications of the present invention without departing from the spirit and scope of the appended claims.

1. A terminal for an electrical connector which is adapted to be surface mounted to a printed circuit board, the terminal comprising:
a base portion;
a contact arm extending from the base portion; and
a lower portion extending from the base portion and including
a leg,
a tail spaced from the leg, the tail including an upright portion, the upright portion having a first surface and a second surface, the second surface being furthest away from the leg, the tail further including a foot extending generally perpendicularly from the second surface of the upright portion in a direction away from the leg,
a notch between the leg and the tail, and
wherein the tail is capable of flexing toward and away from the leg.

2. A terminal as defined in claim 1, wherein the notch is shaped like an arch.

3. A terminal as defined in claim 1, wherein the leg further includes a pushing surface.

4. A terminal as defined in claim 1, wherein the base portion further includes outwardly extending barbs.

5. A terminal as defined in claim 1, wherein the width of the upright portion of the tail is smaller than the width of the leg.

6. A terminal as defined in claim 1 wherein the upright portion of the tail is longer than the leg.

7. A terminal as defined in claim 1, wherein a height of the notch is approximately the same as a height of the leg.

8. An electrical connector which is capable of being surface mounted to a printed circuit board, the electrical connector comprising:
a housing including a top wall with a slot therethrough;
a plurality of terminal passageways within the housing;
a terminal mounted within each of the terminal passageways, each terminal in communication with the slot and including;
a base portion,
a contact arm extending from the base portion,
a lower portion extending from the base portion in a direction away from the contact arm and including
a leg,
a tail including an upright portion, the upright portion having a first surface and a second surface, the second surface being furthest away from the leg, the tail further including a foot extending generally perpendicularly from the second surface of the upright portion in a direction away from the leg,
a notch between the leg and the tail, and
wherein the tail is capable of flexing toward and way from the leg.

9. An electrical connector as defined in claim 8, wherein the base portion of each terminal further includes outwardly extending barbs.

10. An electrical connector as defined in claim 8, wherein the notch of each terminal is shaped like an arch.

11. An electrical connector as defined in claim 8, wherein in each terminal the leg of the lower portion further includes a pushing surface.

12. An electrical connector as defined in claim 8, wherein the upright portion of the tail of each terminal is thinner than the leg of each terminal.

13. An electrical connector as defined in claim 8, wherein the upright portion of the tail of each terminal is longer than the leg of each terminal.

14. An electrical connector as defined in claim 8, wherein a height of the notch is approximately the same as a height of the leg.

15. An electrical connector as defined in claim 8, further including a gap between the housing and each terminal to allow the tail to flex away from the leg.
